(19) United States
(12) Patent Application Publication
(10) Pub. No.: US 2026/0147711 A1
(43) Pub. Date: May 28, 2026

(54) INSTRUCTION CACHE, CIRCULAR BUFFER AND METHOD FOR CONTROLLING ACCESS OF INSTRUCTION CACHE

(71) Applicant: MEDIATEK INC., Hsinchu City (TW)

(72) Inventors: Jiaze Li, San Jose, CA (US); ChenYap Leong, Hsinchu City (TW); Yu Bai, San Jose, CA (US); Chengping Luo, San Jose, CA (US); Jian Mao, San Jose, CA (US); Bozhan Chen, San Jose, CA (US); Litong Song, San Jose, CA (US); You-Ming Tsao, Hsinchu City (TW); Lang Yu, San Jose, CA (US)

(73) Assignee: MEDIATEK INC., Hsinchu City (TW)

(21) Appl. No.: 18/959,563

(22) Filed: Nov. 25, 2024

(51) Int. Cl. G06F 12/0875; G06F 9/38

(52) U.S. Cl. CPC G06F 12/0875; G06F 9/3806; G06F 2212/452

(57) ABSTRACT

An instruction cache, a circular buffer and a method for controlling access of the instruction cache are provided. The instruction cache includes an instruction cache bank, a circular buffer and a selection circuit, where the selection circuit is coupled to the instruction cache bank and the circular buffer. The instruction cache bank is configured to store instructions for a processor. The circular buffer is configured to store a portion of the instructions, where access speed of the circular buffer is faster than access speed of the instruction cache bank. The selection circuit is configured to select one of a first instruction from the instruction cache bank and a second instruction from the circular buffer to be output as an output instruction for the processor according to whether a read address is found in the circular buffer or not.

### BACKGROUND

The present invention is related to shader core designs, and more particularly, to an instruction cache, a circular buffer and a method for controlling access of the instruction cache, which is utilized in a shader core.

In modern graphics processing unit (GPU) designs, a shader core (which is also known as a shader processor or a shader unit) is a specialized processor which is designed to execute programmable shading code, and therefore plays an important role in a GPU. Each GPU of modern designs has multiple shader cores that can work in parallel. A GPU may receive commands from its master, for example, from a central processing unit (CPU). These commands are typically transmitted in a sequence and organized into a stream such as a command stream or a command buffer, where the command buffer undergoes some mechanism to transfer the commands (e.g. high level commands) from the CPU into low-level GPU operations, which are referred to as instructions. Each GPU device may be configured to process a corresponding instruction set, where this instruction set (which includes multiple instructions) are sent to shader cores for final execution.

A warp is a collection of threads which consist of instructions, where instructions within one warp are executed simultaneously by an execution unit (which corresponds to a functional core to execute at least one function such as texture processing, blending and arithmetic operations) in a shader core, and multiple warps can be executed on an execution unit at once. Some frequently utilized instructions can be stored in an instruction cache (which is a level-one cache in the shader core), to allow the execution unit to fetch the instructions from the instruction cache. When the instruction cache in frequently accessed, a great amount of power consumption of read/write operations of memory cells of the instruction cache may be introduced.

Thus, there is a need for a novel architecture of an instruction cache and an associated method, which can reduce the power consumption of the instruction cache without introducing any side effect or in a way that is less likely to introduce side effects.

### SUMMARY

An objective of the present disclosure is to provide an instruction cache, a circular buffer and a method for controlling access of the instruction cache, which can reduce access of the instruction cache to thereby reduce memory power consumption.

At least one embodiment of the present disclosure provides an instruction cache. The instruction cache comprises an instruction cache bank, a circular buffer and a selection circuit, where the selection circuit is coupled to the instruction cache bank and the circular buffer. The instruction cache bank is configured to store instructions for a processor. The circular buffer is configured to store a portion of the instructions, where access speed of the circular buffer is faster than access speed of the instruction cache bank. The selection circuit is configured to select one of a first instruction from the instruction cache bank and a second instruction from the circular buffer to be output as an output instruction for the processor according to whether a read address is found in the circular buffer or not.

At least one embodiment of the present disclosure provides a circular buffer. The circular buffer comprises an address buffer, an instruction buffer and a comparing circuit, where the comparing circuit is coupled to the address buffer. The address buffer is configured to store multiple addresses. The instruction buffer is configured to store multiple instructions respectively corresponding to the multiple addresses. The comparing circuit is configured to determine whether any of the multiple addresses matches a read address, in order to generate a comparison result. In addition, a selection circuit is coupled to the circular buffer and an instruction cache bank, access speed of the instruction buffer is faster than access speed of the instruction cache bank, and the selection circuit is configured to select one of a first instruction output from the instruction cache bank and a second instruction output from the circular buffer to be output as an output instruction according to the comparison result.

At least one embodiment of the present disclosure provides a method for controlling access of an instruction cache. The method comprises: utilizing an instruction cache bank within the instruction cache to store instructions for a processor; utilizing a circular buffer to store a portion of the instructions, wherein access speed of the circular buffer is faster than access speed of the instruction cache bank; and utilizing a selection circuit to select one of a first instruction from the instruction cache bank and a second instruction from the circular buffer to be output as an output instruction for the processor according to whether a read address is found in the circular buffer or not.

The instruction cache, the circular buffer and the method provided by the embodiments of the present disclosure utilize the circular buffer to store the instruction which is utilized previously, in order to reduce a frequency of accessing the instruction cache bank (which is implemented by SRAMs). Thus, SRAM access power can be greatly reduced. In addition, the embodiments of the present invention will not greatly increase additional costs. Thus, the present disclosure can improve an overall performance of a GPU (which comprises the instruction cache) without introducing any side effect or in a way that is less likely introduce side effects.

These and other objectives of the present disclosure n will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a circular buffer built in an instruction cache according to an embodiment of the present invention.

FIG. 3 is a diagram illustrating a circular buffer coupled to an instruction cache according to an embodiment of the present invention.

FIG. 4 is a diagram illustrating a read address being hit in a circular buffer according to an embodiment of the present invention.

FIG. 5 is a diagram illustrating a read address being missed in a circular buffer according to an embodiment of the present invention.

FIG. 6 is a diagram illustrating update of a circular buffer in response to a read address being missed according to an embodiment of the present invention.

FIG. 7 is a diagram illustrating a write address being missed in a circular buffer according to an embodiment of the present invention.

FIG. 8 is a diagram illustrating a write address being hit in a circular buffer according to an embodiment of the present invention.

FIG. 9 is a diagram illustrating a working flow of a method for controlling access of an instruction cache according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

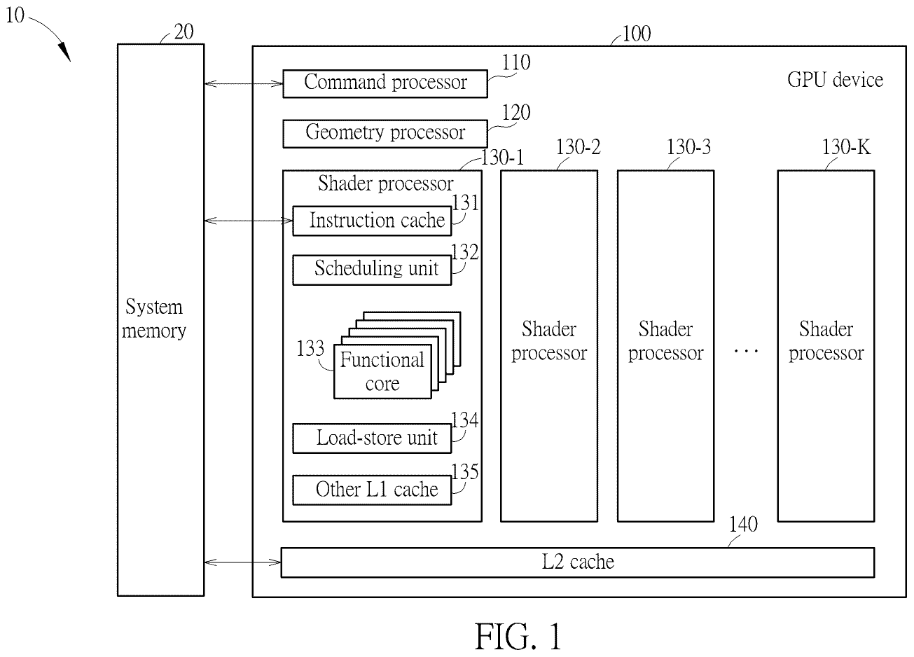

FIG. 1 is a diagram illustrating an electronic device 10 according to an embodiment of the present invention, where the electronic device 10 may comprise a system memory 20 and a graphic processing unit (GPU) device 100, where the GPU device 100 is coupled to the system memory and may access the system memory 20. The GPU device 100 may comprise a command processor 110, a geometry processor 120, multiple shader processors such as N shader processors 130-1, 130-2, 130-3, . . . and 130-N (N may be a positive integer), and a level-2 (L2) cache 140. Each of the shader processors 130-1, 130-2, 130-3, . . . and 130-N (e.g. the shader processor 130-1) may comprise an instruction cache 131 (which may be one of level-one (L1) caches), a scheduling unit 132 (e.g. a scheduling control circuit), multiple functional circuits such as multiple functional cores 133, a load-store unit 134 (e.g. a load store control circuit) and the other level-one L1 cache 135. In this embodiment, access speed of the L2 cache 140 is typically faster than access speed of the system memory 20, and access speed of L1 caches such as the instruction cache 131 and the other cache L1 is typically faster than the access speed of the L2 cache. It should be noted that the present invention is aimed at access control of the instruction cache 131 within each shader core (e.g. the shader core 130-1), where operations of the rest of the components (e.g. the command processor 110, the geometry processor 120, the L2 cache 140, and the scheduling unit 132, the functional cores 133, the load-store unit 134 and the other level-one L2 cache 135 within the shader core 130-1) within the GPU device 100 should be well known by those skilled in this art, and will not be described in detail for brevity.

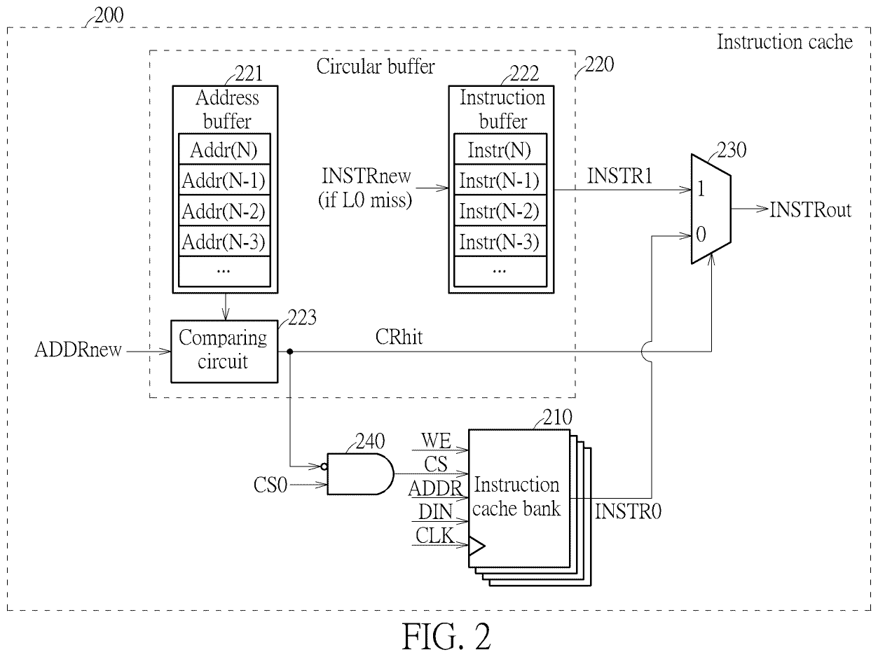

FIG. 2 is a diagram illustrating a circular buffer 220 built in an instruction cache 200 according to an embodiment of the present invention, where the instruction cache 200 may be an example of the instruction cache 131 shown in FIG. 1. As shown in FIG. 2, the instruction cache 200 may comprise an instruction cache bank 210 (which may comprise one or more static random access memory (SRAM) arrays), a circular buffer 220, a selection circuit 230 and a control logic such as an AND gate 240, where the AND gate 240 is coupled to the circular buffer 220, the instruction cache bank 210 is coupled to the AND gate 240, and the selection circuit 230 is coupled to the instruction cache bank 210 and the circular buffer 220. The instruction cache bank 210 is configured to store instructions for a processor (e.g. the shader processor 130-1). For example, access of the instruction cache bank 210 may be controlled according to multiple control signals such as a write enable signal WE, a column select signal CS, an address signal ADDR (which may represent an address to be accessed), an input data signal DIN (which may represent an instruction to be written) and a clock signal CLK. The circular buffer 220 is configured to store a portion of the instructions, where access speed of the circular buffer 220 is faster than access speed of the instruction cache bank 210. For example, the circular buffer 220 may be regarded as a level-zero (L0) memory, and storage units within the circular buffer 220 may be implemented by registers, which have faster access speed in comparison with SRAM units. In addition, the selection circuit 230 is configured to select one of the instruction INSTR0 from the instruction cache bank 210 and the instruction INSTR1 from the circular buffer 220 to be output as an output instruction INSTRout for the processor according to whether a read address ADDRnew is found in the circular buffer 220 or not.

When the processor (e.g. at least one of the functional cores 133) sends the read address ADDRnew to the instruction cache 200 and the read address ADDRnew is found in the circular buffer 220 (which may be referred to as “L0 hit”), the circular buffer 220 may output the instruction INSTR1 according to the read address ADDRnew, and the selection circuit 230 may select the instruction INSTR1 to be output as the output instruction INSTRout. When the processor (e.g. at least one of the functional cores 133) sends the read address ADDRnew to the instruction cache 200 and the read address ADDRnew is not found in the circular buffer 220 (which may be referred to as “L0 miss”), the instruction cache bank 210 may output the instruction INSTR0 according to the read address ADDRnew (e.g. ADDR=ADDRnew), and the selection circuit 230 may select the instruction INSTR0 to be output as the output instruction INSTRout. Besides, when or after the instruction cache bank 210 outputs the instruction INSTR0 according to the read address ADDRnew, the read address ADDRnew and the instruction INSTR0 output from the instruction cache bank 210 (e.g. an instruction INSTRnew) may be written into the circular buffer 220.

In this embodiment, the circular buffer 220 may comprise an address buffer 221, an instruction buffer 222 and a comparing circuit 223, where the comparing circuit 223 is coupled to the address buffer 221. The address buffer 221 is configured to store multiple addresses (e.g. Addr(N), Addr(N-1), Addr(N-2) and Addr(N-3)), and the instruction buffer 222 is configured to store multiple instructions (e.g. Instr(N), Instr(N-1), Instr(N-2) and Instr(N-3)) respectively corresponding to the multiple addresses, where the comparing circuit 223 is configured to determine whether any of the multiple addresses (e.g. any of the addresses Addr(N), Addr(N-1), Addr(N-2), Addr(N-3) . . . ) matches the read address ADDRnew, in order to generate a comparison result CRhit, and the selection circuit 230 may select one of the instruction INSTR0 and the instruction INSTR1 to be output as the output instruction INSTRout according to the comparison result CRhit.

When the comparison result CRhit indicates that a specific address of the multiple addresses matches the read address ADDRnew (e.g., when a specific address of the multiple addresses matches the read address ADDRnew, the comparison result CRhit has a logic value of “1”), the instruction buffer 222 may output a specific instruction corresponding to the specific address as the instruction INSTR1, and the selection circuit 230 may select the instruction INSTR1 to be output as the output instruction INSTRout. When the comparison result CRhit indicates that none of the multiple addresses matches the read address ADDRnew (e.g., when none of the multiple addresses matches the read address ADDRnew, the comparison result CRhit has a logic value of “0”), the instruction cache bank 210 may output the instruction INSTR0 according to the read address ADDRnew, and the selection circuit 230 may select the instruction INSTR0 to be output as the output instruction INSTRout, when or after the instruction cache bank 210 outputs the instruction INSTR0 according to the read address ADDRnew, the read address ADDRnew may be written into the address buffer 221, and the instruction INSTR0 output from the instruction cache bank 210 may be written into the instruction buffer 222 (labeled “INSTRnew (if L0 miss)” in figures for brevity).

Note that the AND gate 240 may control enablement of the control signals of the instruction cache bank 210 according to the comparison result CRhit. More particularly, the AND gate 240 may perform an AND logic operation on an inverted signal of the comparison result CRhit (which is indicated by a circle at an input terminal of the AND gate 240 in figures) and an ordinary control signal (e.g., a column select signal CS0) to generate at least one of the multiple control signals of the instruction cache bank 210 (e.g., the column select signal CS). For example, when the comparison result CRhit indicates that at least one of the multiple addresses matches the read address ADDRnew (e.g. the comparison result CRhit has the logic value of “1”), the AND gate 240 may disable at least one of the control signals of the instruction cache bank 210, such as the column select signal CS (e.g. the ordinary control signal such as the column select signal CS0 may be blocked and the column select signal CS may be fixed at the logic value of “0”), to prevent the instruction INSTR0 from outputting from the instruction cache bank 210. When the comparison result CRhit indicates that none of the multiple addresses matches the read address ADDRnew (e.g. the comparison result CRhit has the logic value of “0”), the AND gate 240 may enable the control signals of the instruction cache bank 210, such as the column select signal (e.g. the ordinary control signal such as the column select signal CS0 may be transmitted to the instruction cache bank 210, i.e. CS=CS0), to make the instruction cache bank 210 output the instruction INSTR0 according to the read address ADDRnew (e.g. ADDR=ADDRnew).

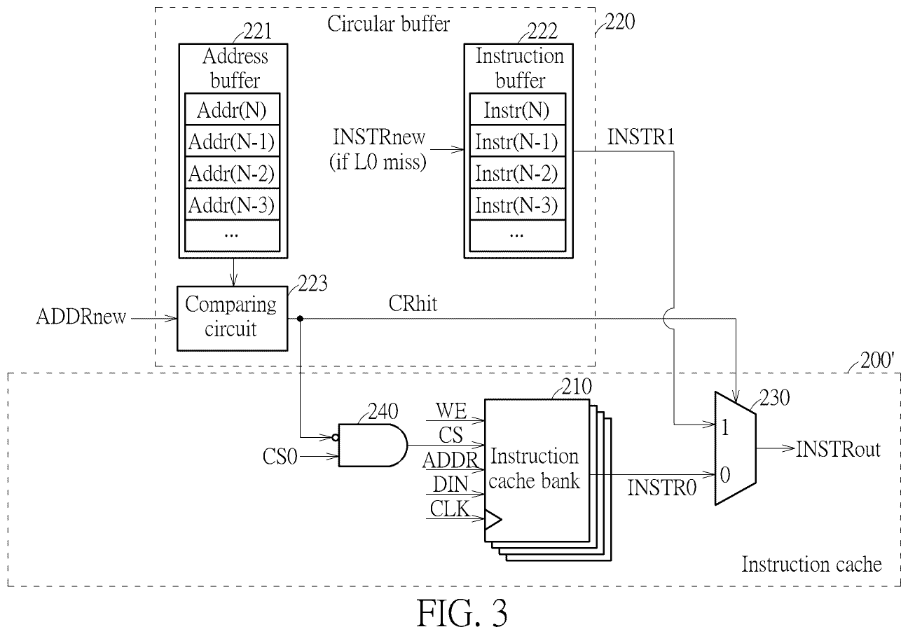

In this embodiment, the circular buffer 220 is implemented as a part of the instruction cache 200, but the present invention is not limited thereto. FIG. 3 is a diagram illustrating the circular buffer 220 coupled to an instruction cache 200′ according to an embodiment of the present invention, where the instruction cache 200′ may be another example of the instruction cache 131 shown in FIG. 1, and the circular buffer 220 is built outside the instruction cache 200′. For example, each of the shader processors 130-1, 130-2, 130-3, . . . and 130-N (e.g., the shader processor 130-1) may further comprise the circular buffer 220, and the circular buffer 220 is couple to the instruction cache 131, but the present invention is not limited thereto.

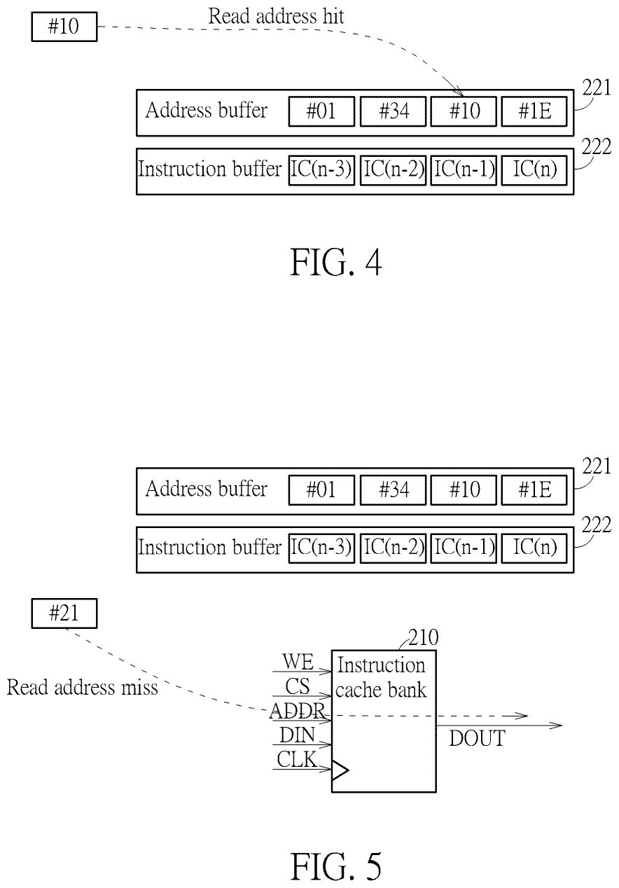

FIG. 4 is a diagram illustrating a read address #10 being hit in the circular buffer 220 (e.g. being hit in the address buffer 221) according to an embodiment of the present invention. As shown in FIG. 4, the address buffer 221 stores addresses #01, #34, #10 and #1E (which may be examples of the addresses Addr(N-3), Addr(N-2), Addr(N-1) and Addr(N) mentioned above, respectively), and the instruction buffer 222 stores instructions IC(n-3), IC(n-2), IC(n-1) and IC(n) (which may be examples of the instructions Instr(N-3), Instr(N-2), Instr(N-1) and Instr(N) mentioned above, respectively), where the instructions IC(n-3), IC(n-2), IC(n-1) and IC(n) correspond to the addresses #01, #34, #10 and #1E, respectively. As shown in FIG. 4, the functional core 133 may send the read address #10 to the instruction cache 200 (or the instruction cache 200′), where the read address #10 can be found in the address buffer 221 (labeled “Read address hit” in FIG. 4), and the instruction buffer 222 may output the instruction IC(n-1) corresponding to the address #10, which is faster than obtaining the instruction IC(n-1) from the instruction cache bank 210. Thus, access to the instruction cache bank 210 can be skipped to thereby saving access power of SRAMs.

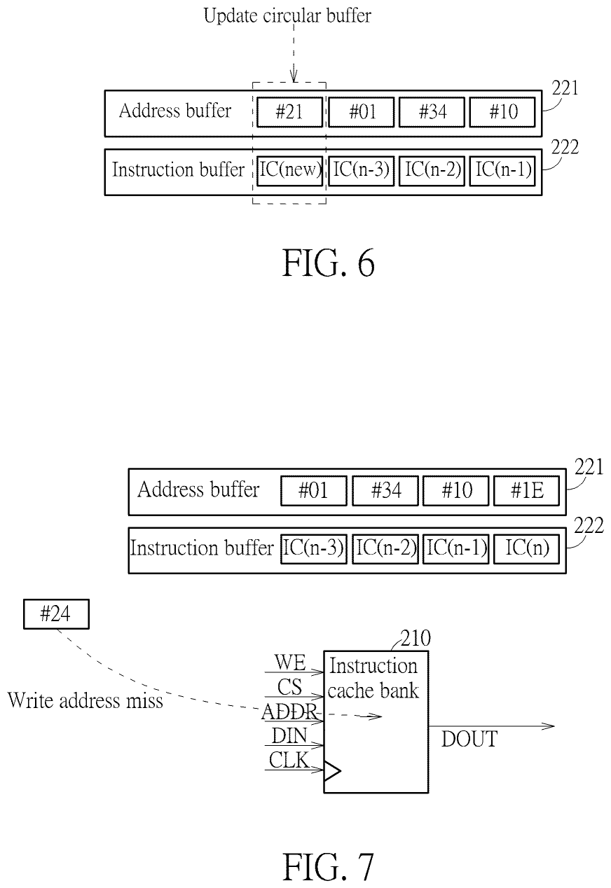

FIG. 5 is a diagram illustrating a read address #21 being missed in the circular buffer 220 (e.g., being missed in the address buffer 221) according to an embodiment of the present invention. As shown in FIG. 5, the functional core 133 may send the read address #21 to the instruction cache 200 (or the instruction cache 200′), when the read address #21 is not found in the address buffer 221, and the instruction cache bank 210 may output an instruction DOUT (which may be an example of the instruction INSTR0 mentioned above) according to the read address #21 (labeled “Read address miss” in FIG. 5) via an output terminal DOUT of the instruction cache bank 210. In addition, the circular buffer 220 (more particularly, the address buffer 221 and the instruction buffer 222) may be updated in response to the read address #21 being missed, where FIG. 6 is a diagram illustrating update of the circular buffer 220 in response to the read address #21 being missed according to an embodiment of the present invention. As shown in FIG. 6, when or after the instruction cache bank 210 outputs the instruction DOUT according to the read address #21, the read address #21 may be written into the address buffer 221, and a new instruction IC(new) (e.g. the instruction DOUT obtained by accessing the instruction cache bank with the read address #21) may be written into the instruction buffer 222. In this embodiment, a replacement scheme of updating the circular buffer is based on a first-in first-out (FIFO) manner, but the present invention is not limited thereto. As long as the circular buffer 220 (e.g., the address buffer 221 and the instruction buffer 222) can be updated in response to miss of a read address, the replacement scheme may be implemented by other manners. Later, when the functional core 133 send the read address #21 to the instruction cache 200 (or the instruction cache 200′), the read address #21 can be found in the address buffer 221, and the instruction buffer 222 may output the instruction IC(new) corresponding to the address #21, which is faster than obtaining the instruction IC(new) from the instruction cache bank 210. Thus, access to the instruction cache bank 210 can be skipped to thereby saving access power of SRAMs.

FIG. 7 is a diagram illustrating a write address #24 being missed in the circular buffer 220 according to an embodiment of the present invention. In particular, when an instruction corresponding to an address (e.g. the write address #24) needs to be updated in the instruction cache bank 210, the functional core 133 may send the write address #24 to the instruction cache 200 (or the instruction cache 200′). In this embodiment, an updated instruction corresponding to the write address #24 may be written into the instruction cache bank 210 (labeled “Write address miss” in FIG. 7). Besides, when or after the updated instruction corresponding to the write address #24 is written into the instruction cache bank 210, the circular buffer 220 may determine whether the write address #24 is found in the address buffer 221 or not, since the write address #24 is not found in the address buffer 221, the circular buffer 220 may operate as usual (e.g. states of the addresses and the instruction stored therein remain unchanged).

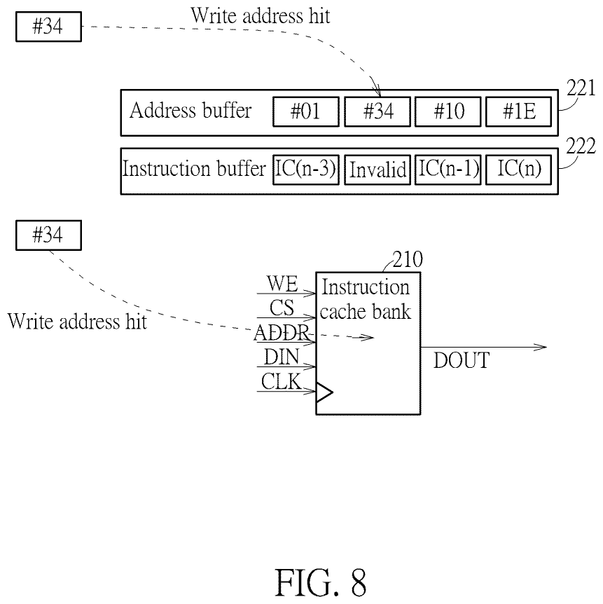

FIG. 8 is a diagram illustrating a write address #34 being hit in the circular buffer 220 according to an embodiment of the present invention. In particular, when an instruction corresponding to an address (e.g. the write address #34) needs to be updated in the instruction cache bank 210, the functional core 133 may send the write address #34 to the instruction cache 200 (or the instruction cache 200′), In this embodiment, an updated instruction corresponding to the write address #34 may be written into the instruction cache bank 210 (labeled “Write address hit” in FIG. 8). Besides, when or after the updated instruction corresponding to the write address #34 may be written into the instruction cache bank 210, the circular buffer 220 may determine whether the write address #34 is found in the address buffer 221 or not, as the write address #34 is found in the address buffer 221 but a specific instruction stored in the instruction buffer 222 corresponding to the address #34 is an old version, which may be different from the updated instruction), this specific instruction stored in the instruction buffer 222 corresponding to the write address may be marked as an invalid instruction. For example, a flag configured to indicate validity of an entry of this specific instruction may be written to a specific logic value to indicate that this entry is invalid, but the present invention is not limited thereto. Thus, if a read address #34 is received later, the circular buffer 220 may report a miss, in order to prevent the invalid instruction from being utilized.

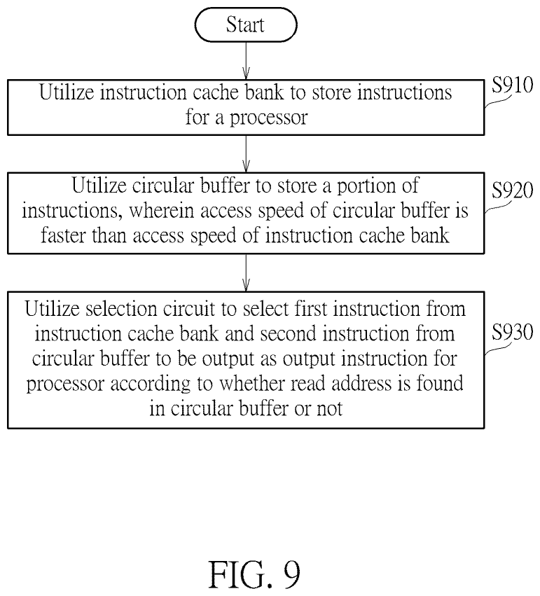

FIG. 9 is a diagram illustrating a working flow of a method for controlling access of an instruction cache (e.g., the instruction cache 200 or 200′) according to an embodiment of the present invention. It should be noted that the working flow shown in FIG. 9 is for illustrative purposes only, and is not meant to be a limitation of the present invention. For example, one or more steps may be added, deleted or modified in the working flow shown in FIG. 9. In addition, if a same result can be obtained, these steps do not have to be executed in the exact order shown in FIG. 9.

In Step S910, utilizing an instruction cache bank (e.g. the instruction cache bank 210) within an instruction cache to store instructions for a processor (e.g. the shader processor 130-1).

In Step S920, utilizing a circular buffer (e.g., the circular buffer 220) inside or outside the instruction cache to store a portion of the instructions, where access speed of the circular buffer (which has storage units implemented by registers) is faster than access speed of the instruction cache bank (which has storage units implemented by SRAMs).

In Step S930, utilizing a selection circuit (e.g., the selection circuit 230) to select a first instruction from the instruction cache bank and a second instruction from the circular buffer to be output as an output instruction for the processor according to whether a read address is found in the circular buffer or not.

For the GPU device 100, when a shader core program, which comprises multiple instructions, is executed with a smaller warp size (e.g., a smaller number of instructions being grouped in one warp, such as 16 or less instructions being grouped in one warp), a greater number of warps may be needed in order to finish the shader core program. Thus, access to the instruction cache 131 for reading out the instructions may be more often, which also increases a probability of reading out the same instruction. With configuration of the circular buffer 220, an instruction which is already utilized previously may be stored in the circular buffer 220, which allows the functional core 133 to obtain this instruction from the circular buffer 220 without accessing the instruction cache bank 210, thereby reducing access power of SRAMs.

To summarize, the instruction cache 200/200′, the circular buffer 220 and the method provided by the embodiments of the present invention can store the instruction, which has been utilized previously, into the circular buffer 220. As the access speed of the circular buffer 220 is faster than the instruction cache bank 210 and access power of the circular buffer 220 (e.g. register access power) is much less than access power of the instruction cache bank 210 (e.g. SRAM access power), an overall performance (e.g. power efficiency) can be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An instruction cache, comprising:
an instruction cache bank, configured to store instructions for a processor;
a circular buffer, configured to store a portion of the instructions, wherein access speed of the circular buffer is faster than access speed of the instruction cache bank; and
a selection circuit, coupled to the instruction cache bank and the circular buffer, and configured to select one of a first instruction from the instruction cache bank and a second instruction from the circular buffer to be output as an output instruction for the processor according to whether a read address is found in the circular buffer or not.

2. The instruction cache of claim 1, wherein when the read address is found in the circular buffer, the circular buffer is configured to output the second instruction according to the read address, and the selection circuit is configured to select the second instruction to be output as the output instruction.

3. The instruction cache of claim 1, wherein when the read address is not found in the circular buffer, the instruction cache bank is configured to output the first instruction according to the read address, and the selection circuit is configured to select the first instruction to be output as the output instruction.

4. The instruction cache of claim 3, wherein the read address and the first instruction output from the instruction cache bank are written into the circular buffer when or after the instruction cache bank outputs the first instruction according to the read address.

5. The instruction cache of claim 1, wherein the circular buffer comprises:
an address buffer, configured to store multiple addresses;
an instruction buffer, configured to store multiple instructions respectively corresponding to the multiple addresses; and
a comparing circuit, coupled to the address buffer, and configured to determine whether any of the multiple addresses matches the read address, in order to generate a comparison result;
wherein the selection circuit is configured to select one of the first instruction and the second instruction to be output as the output instruction according to the comparison result.

6. The instruction cache of claim 5, wherein when the comparison result indicates that a specific address of the multiple addresses matches the read address, the instruction buffer is configured to output a specific instruction corresponding to the specific address to be the second instruction, and the selection circuit is configured to select the second instruction to be output as the output instruction.

7. The instruction cache of claim 5, wherein when the comparison result indicates that none of the multiple addresses matches the read address, the instruction cache bank is configured to output the first instruction according to the read address, and the selection circuit is configured to select the first instruction to be output as the output instruction.

8. The instruction cache of claim 7, wherein the read address is written into the address buffer, and the first instruction output from the instruction cache bank is written into the instruction buffer when or after the instruction cache bank outputs the first instruction according to the read address.

9. The instruction cache of claim 5, wherein the instruction cache bank is further configured to receive and store an instruction in response to a write address, and when the write address is found in the address buffer a specific instruction stored in the instruction buffer corresponding to the write address is marked as an invalid instruction.

10. A circular buffer, comprising:
an address buffer, configured to store multiple addresses;
an instruction buffer, configured to store multiple instructions respectively corresponding to the multiple addresses; and
a comparing circuit, coupled to the address buffer, configured to determine whether any of the multiple addresses matches a read address, in order to generate a comparison result;
wherein a selection circuit is coupled to the circular buffer and an instruction cache bank, access speed of the instruction buffer is faster than access speed of the instruction cache bank, and the selection circuit is configured to select one of a first instruction output from the instruction cache bank and a second instruction output from the circular buffer to be output as an output instruction according to the comparison result.

11. The circular buffer of claim 10, wherein when the comparison result indicates that a specific address of the multiple addresses matches the read address, the instruction buffer is configured to output a specific instruction corresponding to the specific address to be the second instruction, and the selection circuit is configured to select the second instruction to be output as the output instruction.

12. The circular buffer of claim 10, wherein when the comparison result indicates that none of the multiple addresses matches the read address, the instruction cache bank is configured to output the first instruction according to the read address, and the selection circuit is configured to select the first instruction to be output as the output instruction.

13. The circular buffer of claim 12, wherein the read address is written into the address buffer, and the first instruction output from the instruction cache bank is written into the instruction buffer when or after the instruction cache bank outputs the first instruction according to the read address.

14. The circular buffer of claim 10, wherein when the instruction cache bank receives and stores an instruction in response to a write address, and the write address is found in the address buffer, a specific instruction stored in the instruction buffer corresponding to the write address is marked as an invalid instruction.

15. A method for controlling access of an instruction cache, comprising:
utilizing an instruction cache bank within the instruction cache to store instructions for a processor;
utilizing a circular buffer to store a portion of the instructions, wherein access speed of the circular buffer is faster than access speed of the instruction cache bank; and
utilizing a selection circuit to select one of a first instruction from the instruction cache bank and a second instruction from the circular buffer to be output as an output instruction for the processor according to whether a read address is found in the circular buffer or not.

16. The method of claim 15, further comprising:
in response to the read address being found in the circular buffer, utilizing the circular buffer to output the second instruction according to the read address; and
utilizing the selection circuit to select the second instruction to be output as the output instruction.

17. The method of claim 15, further comprising:
in response to the read address being not found in the circular buffer, utilizing the instruction cache bank to output the first instruction according to the read address; and
utilizing the selection circuit to select the first instruction to be output as the output instruction.

18. The method of claim 15, further comprising:
utilizing a comparing circuit to determine whether any of multiple addresses stored in an address buffer of the circular buffer matches the read address, in order to generate a comparison result;
wherein utilizing the selection circuit to select one of the first instruction and the second instruction to be output as the output instruction for the processor according to whether the read address is found in the circular buffer or not comprises:
utilizing the selection circuit to select one of the first instruction and the second instruction to be output as the output instruction according to the comparison result.

19. The method of claim 18, further comprising:
in response to the comparison result indicating that a specific address of the multiple addresses matches the read address, utilizing an instruction buffer of the circular buffer to output a specific instruction corresponding to the specific address to be the second instruction;
wherein utilizing the selection circuit to select one of the first instruction and the second instruction to be output as the output instruction according to the comparison result comprises:
utilizing the selection circuit to select the second instruction to be output as the output instruction.

20. The method of claim 18, further comprising:
in response to the comparison result indicating that none of the multiple addresses matches the read address, utilizing the instruction cache bank to output the first instruction according to the read address;
wherein utilizing the selection circuit to select one of the first instruction and the second instruction to be output as the output instruction according to the comparison result comprises:
utilizing the selection circuit to select the first instruction to be output as the output instruction.
